(19) United States
(12) Patent Application Publication
(10) Pub. No.: US 2007/0033846 A1
(43) Pub. Date: Feb. 15, 2007

(54) 3-Dimensional optically interactive card carrier presentation package

(76) Inventor: George Bogdonovic, St. Charles, IL (US)

Correspondence Address: Clifford Kraft, Suite 274, 27 N. Wacker Dr., Chicago, IL, 60606, US

(21) Appl. No.: 11/200,607

(22) Filed: Aug. 10, 2005

(51) Int. Cl. G09F 3/18

(52) U.S. Cl. 40/661

(57) ABSTRACT

A card carrier and presentation device that can assume a flat 2-dimensional configuration and be deformed into a 3-dimensional configuration. The flat configuration is used to carrier the card on a rack for vending. When the card and device is purchased, the card can be removed and inserted into the device after it is deformed into the 3-dimensional configuration. The card can become part of the 3-dimensional structure. The device can be transparent and have optional artwork on a surface that can optically interact with artwork on the card when the device is in the 3-dimensional configuration to create a combined visual effect.

### BACKGROUND

1. Field of the Invention

The present invention relates generally to presentation packages for cards and more particularly to a 3-dimensional optically interactive card carrier presentation package.

2. Description of the Prior Art

It is known to present gift cards, telephone cards, greeting cards and other types of cards in flat packages or hangers. In most cases, cards are on a paper or plastic card carrier that can be hung on a self-dispensing rack. Sometimes these cards and carriers have artistic or ornamental features. Generally they are flat and rectangular.

Prior art cards can be attached to a flat carrier by hot melt fugitive glue, tape or other means. In general, the user removes the card and discards the carrier.

It would be advantageous to have a carrier device that would hang flat on a dispensing rack with the card attached, but that could be distorted or folded into a 3-dimensional presentation configuration with the card being part of the 3-dimensional structure. It would also be advantageous to have artwork on the carrier device interact with artwork on the card.

### SUMMARY OF THE INVENTION

The present invention relates to a 3-dimensional card presentation carrier device that can be used itself as a gift for presentation of the card. The carrier can have a design or artwork that interacts optically with a design or artwork on the card itself. The carrier can be flat in a 2-dimensional configuration mode for hanging on a dispensing rack, and fold or be distorted into a 3-dimensional configuration by inserting the card or otherwise making the card part of the structure. An optional hanging tab could be removable in the 3-dimensional mode. The device can be made of transparent material such as clear plastic so that any design or artwork on the carrier can optionally interact with artwork on the card.

An example of use of the present invention might be that a parent wants to give a gift of a debit card to a teenager. The card and flat carrier device can be taken off the dispensing rack and purchased. When it is desired to present the gift, the carrier device could be distorted or folded into a 3-dimensional configuration and held in that state by inserting the card into the 3-dimensional structure in a predetermined way. The carrier could be clear plastic with say a water/bubble design. The card could have a fish design. When the card was inserted into the structure, the water/bubble design could optically interact with the fish design on the card giving the illusion of a fish under water.

### DESCRIPTION OF THE DRAWINGS

FIG. 1 shows a card on a carrier in a 2-dimensional configuration.

FIG. 2 shows the carrier from FIG. 1 distorted or unfolded into a 3-dimensional configuration with the card inserted as part of the structure.

FIG. 3 shows the embodiment of FIG. 2 with the hanging tab removed.

FIGS. 4a-4B show a different embodiment of the present invention.

Several illustrations and drawings have been presented to better aid in the understanding of the present invention. The scope of the present invention is not limited to what is shown in the figures.

### DESCRIPTION OF THE INVENTION

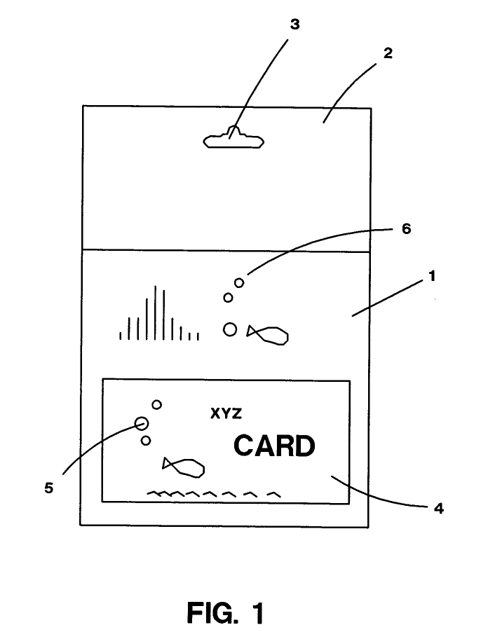

The present invention relates to a card carrier and presentation device and method where a carrier device can assume both a 2-dimensional configuration and a 3-dimensional configuration. Turning to FIG. 1, an embodiment in a 2-dimensional configuration is shown. A clear plastic or other transparent carrier 1 is hung on a carrier or dispensing rack by means of a hole 3 located near the top portion or tab 2. A card 4, such as a gift debit or telephone card, is attached to the bottom portion of the carrier 1. The card 4 can be attached to the carrier 1 with a small amount of fugitive glue or by any other attachment means. The carrier 1 can contain optional artwork 6 or designs. The card 4 can also contain optional other artwork 5 or designs possibly related in theme to the artwork 6 on the carrier 1. Cards can be credit cards, debit cards, telephone cards, gift cards, business cards, greeting cards, or any other type of card of any shape or material for any purpose. Generally cards are made of hard plastic like credit cards; however it is with in the scope of the present invention to both the cards and the carrier from any material.

The carrier can be constructed from two thin layers of material like clear plastic in a particular embodiment of the present invention. The layers can be laid on top of one another in the 2-dimensional mode with layers attached to each other top and bottom or in other manner to produce the ultimate 3-dimensional structure when the structure is distorted. Alternatively, a single layer can be folded or creased at the bottom and then attached about ⅔ or ¾ of the way to the top. The card can be attached for sale to the device by fugitive glue or by any other means.

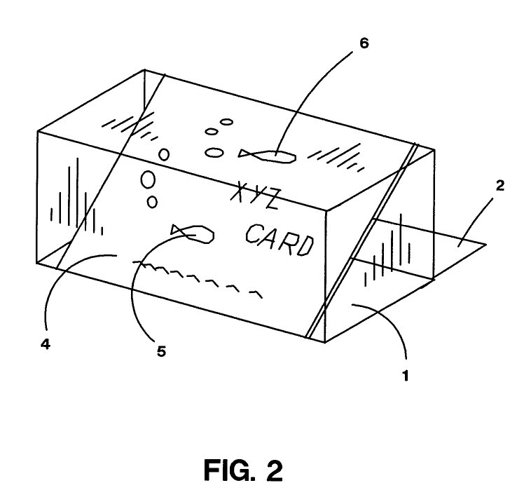

After the carrier and card are purchased, the buyer can fold or deform the carrier 1 into a 3-dimensional configuration an example of which is shown in FIG. 2. FIG. 2 shows the carrier of FIG. 1 distorted along predefined crease lines into a 3-dimensional configuration and held in that configuration by insertion of the card across the diagonal of the box-like structure. In this particular example, the card simply fits in predetermined creases to hold the 3-dimensional structure together. However, in some cases, with some 3-dimensional designs, holes or tabs may be provided to hold the card in the structure. It should be noted that any shape or design can be used for the carrier. The carrier can be made of any material that is flexible. The preferred material is transparent plastic sheet.

A feature of the present invention is that designs or artwork 6 on the carrier device can optically interact with designs or artwork 5 on the card. FIGS. 1 and 2 show an example of fish and bubbles on both the clear plastic carrier device and the opaque plastic card face. In the 3-dimensional configuration, the user receives the optical impression of fish swimming in a 3-dimensional space.

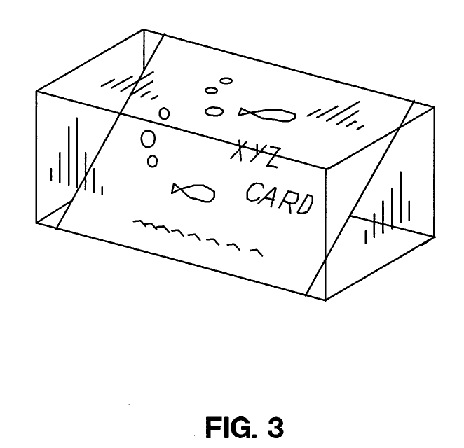

The tab 2 or part of the device used for hanging in the 2-dimensional configuration can be made removable. FIG. 3 shows the embodiment of FIG. 2 with the tab removed. While removing the tab is optional (or making the tab removable is optional), it can lead to a more presentable and complete looking gift.

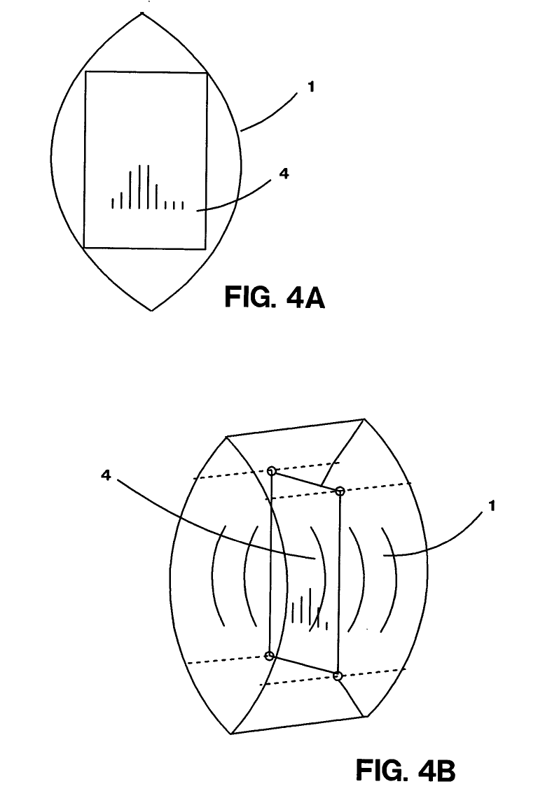

It should be noted that carriers can be made to fold or distort into any 3-dimensional geometrical shape from a 2-dimensional flat configuration. FIGS. 4A and 4B show a completely different geometrical shape resembling a tree ornament. FIG. 4A is an end view, while FIG. 4B is a perspective view of this embodiment. This shape has a generally oval appearance. Carriers can be any shape in the 2-dimensional configuration and need not be rectangular, although rectangular is the most common to fit dispensing racks. The card can be held in the 3-dimensional configuration in any manner or position with the preferred method being that the card stabilizes and holds the carrier in the 3-dimensional configuration. Carriers can be made of any material with clear plastic being preferred so that designs on the plastic carrier device can optically interact with designs on the card. Any means can be used to hold the card in the carrier in the 3-dimensional configuration including holes, tabs creases or simply the shape of the configuration.

The use of optically interacting designs (or designs of any kind) is optional; however, the use of optically interacting designs enhances the card presentation experience dramatically leading to a very special gift.

Various descriptions, illustrations and examples have been presented to better aid in the understanding of the present invention. One skilled in the art will recognize that numerous designs are possible along with many changes and variations. All of these designs, shapes, changes and variations are within the scope of the present invention. The scope of the present invention is not limited to the illustrations, embodiments or examples given.

I claim:

1. A card presentation device having a 2-dimensional and a 3-dimensional configuration where a card is flatly attached to the device in the 2-dimensional configuration and wherein said card can be inserted to become part of said 3-dimensional configuration.

2. The card presentation device of claim 1 further comprising an artwork design on the device.

3. The card presentation device of claim 1 further comprising an artwork design on the card.

4. The card presentation device of claim 1 further comprising a first artwork design on the device and a second artwork design on the card, wherein the first artwork design and the second artwork design optically interact in said 3-dimensional configuration.

5. The card presentation device of claim 1 wherein the card structurally supports said 3-dimensional configuration.

6. The card presentation device of claim 1 wherein the device is transparent plastic.

7. The card presentation device of claim 1 wherein the card has a rectangular shape.

8. A 3-dimensional card presentation device comprising a pair of clear material layers attached such that they can be deformed into a 3-dimensional shape with a first of said layers forming an outer member and a second of said layers forming an inner member, said outer and inner members being held in said 3-dimensional shape by insertion of a card.

9. The 3-dimensional card presentation device of claim 8 wherein at least one of said layers contains an artwork design.

10. The 3-dimensional card presentation device of claim 8 wherein said card contains an artwork design.

11. The 3-dimensional card presentation device of claim 8 further comprising a first artwork design on at least one of said layers and a second artwork design on said card, said first artwork and said second artwork design optically interacting in said 3-dimensional shape.

12. A method of presenting cards for sale and for gifts comprising the steps of:
placing a front material layer over a backing layer;
causing said layers to be attached to one-another;
removably attaching a card to said front material layer;
allowing said card to be removed from said front material layer and inserted between said front material layer and said backing layer causing said layers to separate and form a 3-dimensional shape, whereby said card can be presented to a recipient in said 3-dimensional shape.

13. The method of claim 12 further comprising putting a first artwork design on said front material and a second artwork design on said card such that said first artwork design and said second artwork design optically interact when said layers take said 3-dimensional shape.

14. The method of claim 12 wherein said front material layer is transparent.

15. The method of claim 12 wherein said card has a rectangular shape.

16. The method of claim 12 wherein said card is a gift card.

17. The method of claim 12 wherein said card is a greeting card.

18. The method of claim 12 wherein said card is a telephone card.
